(19) United States
(12) Patent Application Publication
(10) Pub. No.: US 2001/0017366 A1
(43) Pub. Date: Aug. 30, 2001

(54) Device for setting and automatic adjustment of the tractive force of a cable of an overhead winch for a ski slope preparation and maintenance machine

(75) Inventor: Michael Rechenmacher, Vipiteno (IT)

Correspondence Address: Shlesinger, Fitzsimmons & Shlesinger, Suite 1323, 183 East Main Street, Rochester, NY, 14604, US

(73) Assignee: Leitner S.p.A.,

(21) Appl. No.: 09/766,459

(22) Filed: Jan. 17, 2001

(30) Foreign Application Priority Data
Jan. 21, 2000 (IT) BZ 2000 A 000 005

(51) Int. Cl. B66D 1/50; B66D 1/00

(52) U.S. Cl. 254/274; 254/323; 254/361

(57) ABSTRACT

A device for setting and automatic adjustment of the tractive forces of the cable of an overhead winch for a ski slope preparation and maintenance machine comprising an adjustment control unit connected to a controllable winch drive and a processing device connected to sensors and to the adjustment control unit is described.

In accordance with the present invention the sensors are pressure sensors which detect the pressure applied to a selection valve (16,20) with maximum value with said valve being connected between the delivery ducts (6,8) of the drives on the right- and left-hand sides in a first travel direction or a travel direction opposite thereto with there being deposited in the processing device an algorithm which calculates a nominal value based on the pressure taken by the pressure sensors and which controls winch operation through the adjustment control unit.

### DESCRIPTION

The present invention relates to a device for setting and automatic adjustment of the tractive force of the cable of an overhead winch for a ski slope preparation and maintenance machine in accordance with the classifying part of claim 1.

To maintain a predetermined pulling force of a cable there are known winch adjustment devices for influencing a controllable winch operation in such a manner that exceeding or falling short of the adjusted tractive forces is avoided. Increased stress on the cable can lead to cable breakage with serious consequences. In addition the adjustment devices of known type do not allow for the dynamics of a vehicle on which they are installed and in particular the different angular positions which the cable can assume with respect to the vehicle. Due to the fact that the cable force adjustment devices in known winches are only adjustable for the nominal admissible cable tension, allowance is not made for vehicle travel circumstances and the cable is subject to tractive forces of needless magnitude for performance of certain ooperations. This needlessly reduces cable life.

The general purpose of the present invention is to remedy the above mentioned shortcomings by making available a device for setting and automatic adjustment of the tractive force allowing for the circumstances of a ski slope preparation and maintenance machine with the purpose of making the necessary tractive force available at all times but at the same time limiting it to the amount strictly necessary. In addition a nominal tractive force should be set automatically.

This purpose is achieved in accordance with the present invention by a device for setting and automatic adjustment of the tractive force of an overhead winch for a ski slope preparation and maintenance machine by providing the characteristics of the characterizing part of claim 1.

With the aid of an adjustment control unit and an algorithm deposited in it from different measurements taken by sensors a nominal tractive force is determined. The nominal value is made up of the hydrostatic cable operation pressure of travel and the cable angle in relation to the vehicle as well as a correction factor predetermined by the operator. In a closed adjustment circuit located downstream the nominal value thus taken is compared with the real value measured by a dynamometric pin and the tractive force is adjusted to the nominal value.

As a measurement of the necessary tractive force there is the travel operation pressure. If for example the winch cable is located forward in the direction of travel and a high pressure is located on the ‘leading side’ of the travel operation, then the winch tractive force should also be chosen correspondingly high. But if the pressure is applied on the ‘trailing side’ to the winch cable directed in the direction of travel it means that the overhead winch is working against the travel traction. In this case the winch tractive force should be set very low.

In addition the winch tractive force should be reduced if it is engaged transversely to the direction of travel. If because of unfavorable snow conditions (for example fresh snow) the adjustment control unit supplies erroneous nominal values for tractive force the operator has the option of oversteering and specifically of making possible a tractive force increase or reduction.

Additional characteristics and advantages of the device in accordance with the present invention are set forth in the claims and the description given below of a preferred embodiment with reference to the annexed drawings. In the drawings

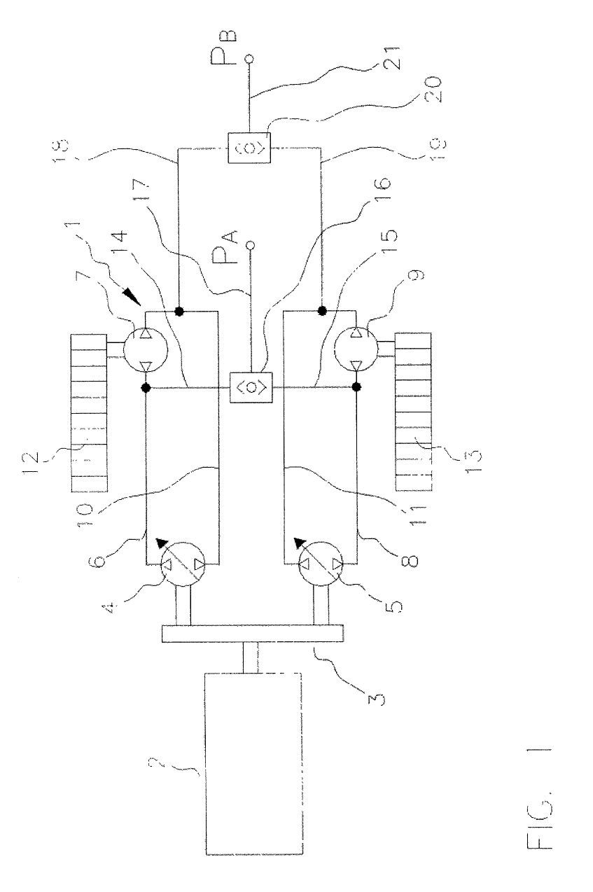

FIG. 1 shows a diagram of the device in accordance with the present invention applied to a ski slope preparation and maintenance machine of known type,

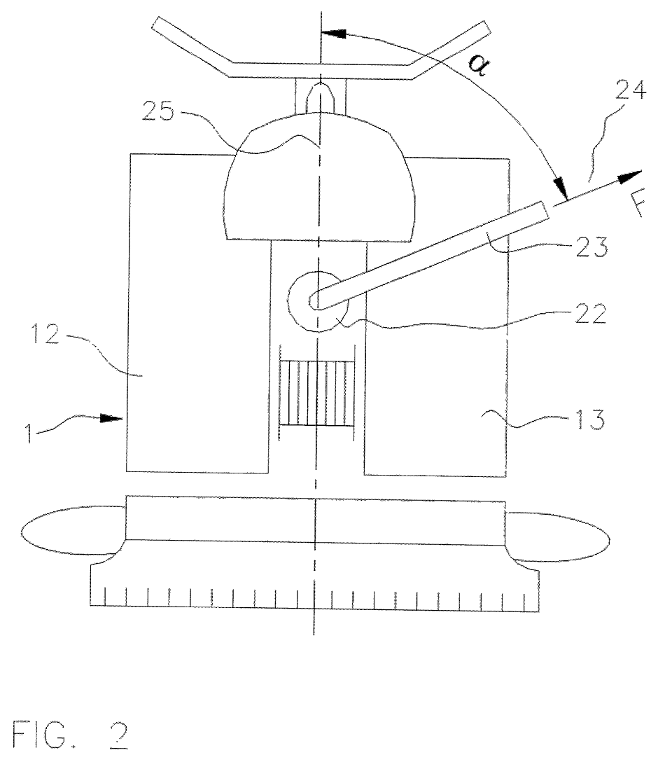

FIG. 2 shows diagrammatically a ski slope preparation and maintenance machine with overhead winch,

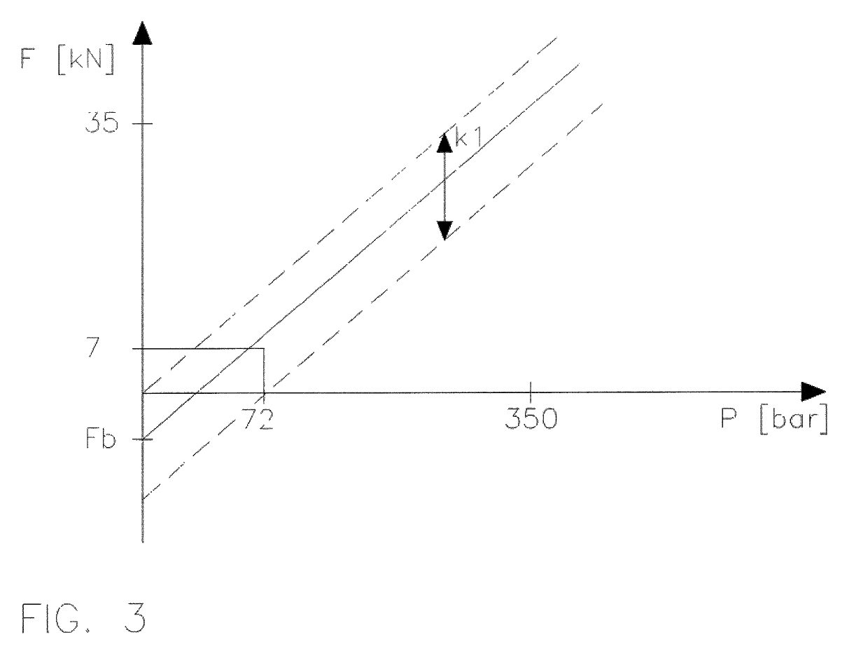

FIG. 3 shows a diagram for finding a tractive force,

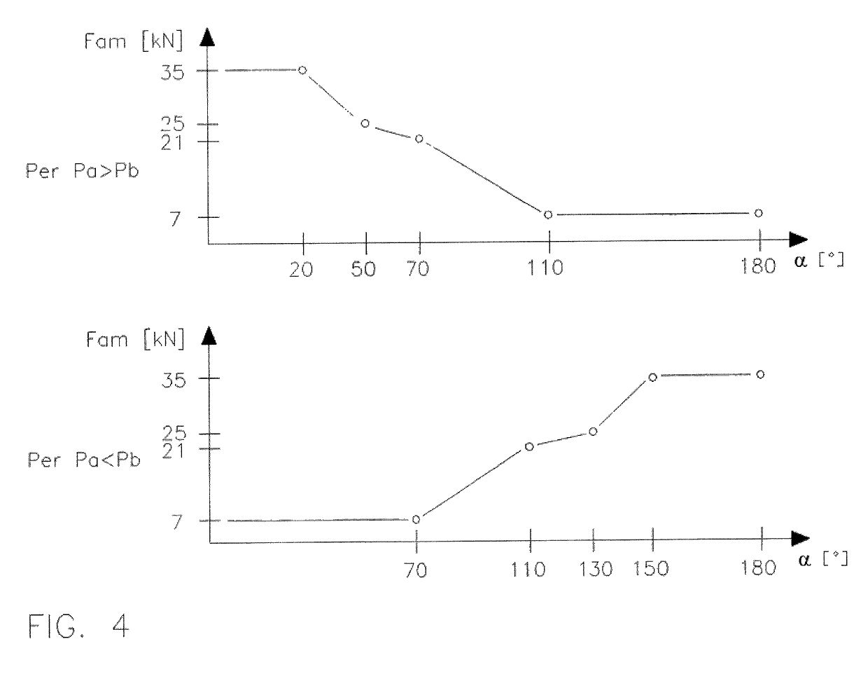

FIG. 4 shows a diagram for finding the highest allowable tractive force, and

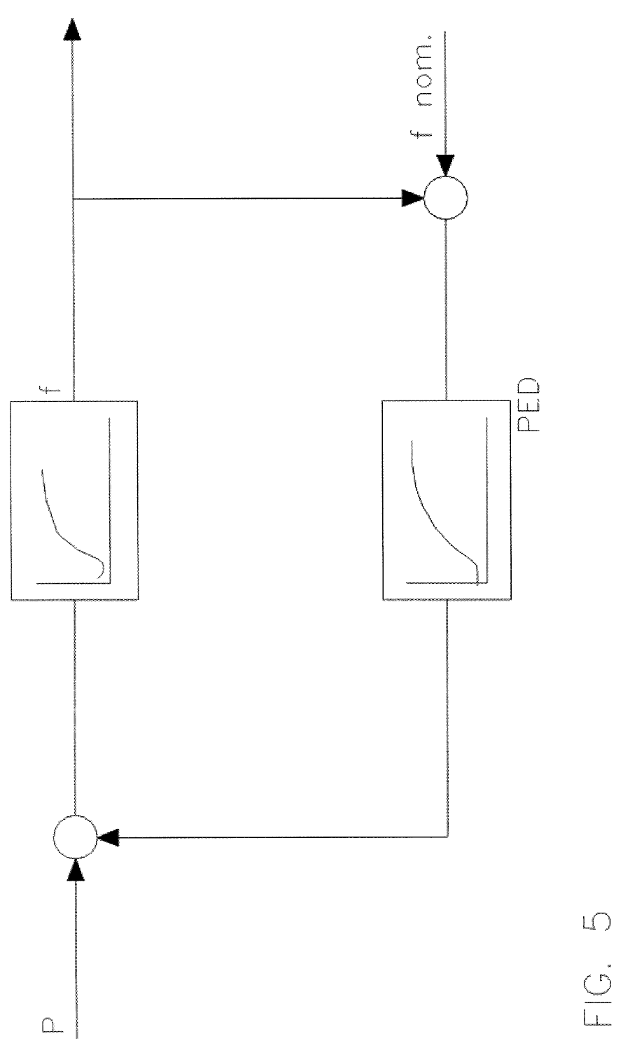

FIG. 5 show diagrammatically an adjustment circuit for comparison of a real tractive force and adjustment of the real to the nominal tractive force.

With reference to the FIGS a ski slope preparation and maintenance machine of known type is designated as a whole be reference number 1. It comprises for example a diesel engine 2 which through a transmission 3 drives a first pump 4 and a second pump 5. The hydraulic pump 4 feeds through a delivery duct 6 a hydraulic motor 7 or the pump 5 feeds through a delivery duct 8 a hydraulic motor 9 with fluid under pressure. The hydraulic motor 7 is connected through a return duct 10 and the hydraulic motor 9 through a return duct 11 with the pumps 4 and 5 respectively. The hydraulic motor 7 drives a track 12, right hand seen in the direction of travel, and the hydraulic motor 9 a left hand track 13. The parts described thus far of a ski slope preparation and maintenance machine are of known type and are useful only in improving understanding of the following description of the device in accordance with the present invention. The terms delivery duct and return duct refer to ‘forward travel’ and assume the reverse meaning in the case of ‘rearward travel’.

The delivery duct 6 is connected through a branch 14 and the delivery duct 8 through a branch 15 with a selection valve 16 capable of allowing detection of the higher of the two pressures in the ducts 6 and 8 through a duct 17 from a pressure sensor A.

In similar manner the return duct 10 is connected through a branch 18 and the return duct 8 through a branch 19 with a selection valve 20 connected through a duct 21 with a pressure sensor B.

Thus, both the pressure sensors A and B are used to measure the pressure in travel operation. The sensor A is connected through the selection valve 16 with the ‘leading sides’ and the sensor B is connected through the selection valve 20 with the ‘trailing sides’ of both the hydrostatic travel drives in the form of hydraulic motors 7 and 9. In this manner the higher pressure of the ‘forward side’ or ‘rearward side’ of the left or right travel drive respectively is applied on both sensors A and B.

FIG. 2 shows the ski slope preparation and maintenance machine of FIG. 1 diagrammatically from above. An overhead winch is symbolized at reference number 22. It has an arm 23 of the winch guiding the winch cable 24 within an angle α with respect to the travel direction 25 of the ski slope preparation and maintenance machine 1.

The angle α of the cable 24 or the winch arm 23 relative to the steering axis of the vehicle or the travel direction 25 is determined with the aid of a rotation angle transmitter of known type and not shown which supplies a tension signal proportionate to angle α. If the winch arm 23 is forward in the travel direction it corresponds to α=0°. If it is in rearward travel direction it corresponds to an angle α=180°. The angle signal is equal for positive and negative angles (for example an angle of α=60° gives the same signal as an angle of α=−60° or α=300° respectively) since a distinction between right and left side is unimportant for tractive force determination.

Through a potentiometer not shown an adjustment value can be set by the operator. The winch tractive force adjustment control unit which works fully automatically in normal operation can be controlled by the operator with adjustment of a correction factor. The potentiometer used for this purpose can be deflected from a central position elastically loaded in a positive and negative direction. In this manner it is possible to reduce or increase the nominal tractive force determined automatically by the adjustment control unit depending on requirements. After release of the potentiometer it returns automatically with the central position so that the correction factor is zero and the tractive force nominal value is again taken fully automatically.

Determination of the nominal tractive force in the adjustment control unit takes place in two steps as follows.

As shown in FIG. 3, subject to the pressure p in the travel drive and the correction factor K₁ which can be adjusted by the operator through the potentiometer, the tractive force factor F* is determined with reference to FIG. 3 as follows.

F*(p·K₁)=m·p+F₀+K₁

where

p=travel operation pressure (the greater of the pressures P_{A} and P_{B})

F₀=0.38 kN

K₁=correction factor [−12 kN<K₁<12 kN], adjustable by the operator through the potentiometer.

In a second step in accordance with FIG. 4 depending on the angle α of the winch arm and application of the pressures P_{A} and P_{B} the highest admissible force Fₐₘ is determined from the upper diagram of FIG. 4 which is to be applied for ‘leading side’ pressure and the lower diagram for ‘trailing side’ pressure.

The lesser of the values F* and Fₐₘ is the nominal tractive force value Fₙₒₘ.

In a closed adjustment circuit this value is compared with the tractive force Fᵣₑₐₗ and the real value is adjusted to the nominal value.

1. Device for setting and automatic adjustment of the tractive forces of the cable of an overhead winch for a ski slope preparation and maintenance machine comprising an adjustment control unit connected to a controllable winch drive and a processing device connected to sensors and to the adjustment control unit characterized in that the sensors are pressure sensors which detect the pressure applied to a selection valve (16,20) with maximum value with said valve being connected between the delivery ducts (6,8) of the drives on the right- and left-hand sides in a first travel direction or a travel direction opposite thereto with there being deposited in the processing device an algorithm which calculates a nominal value based on the pressure taken by the pressure sensors and which controls winch operation through the adjustment control unit.

2. Device in accordance with claim 1 characterized in that the nominal value taken by the adjustment unit is compared with a real value measured by a dynamometric pin applied to the traction cable and the adjustment unit adjusts the tractive force to the nominal value.

3. Device in accordance with the above claims characterized in that one of the sensors is a rotation angle transmitter which determines the angle α of the winch cable (24) or arm (23) relative to the longitudinal axis (25) of the vehicle with there being formed a signal proportional to the angle α which is fed to the processing unit for calculation of the maximum admissible tractive force.

4. Device in accordance with the above claims characterized in that one of the sensors is made up of the dynamometric pin applied to the cable for formation of a maximum admissible nominal tractive force.

5. Device in accordance with the above claims characterized in that to the adjustment unit is connected a potentiometer which can be set by the ski slope preparation and maintenance machine operator and allows input of a correction factor to increase or reduce the detected nominal tractive force.
